(19) United States
(12) Patent Application Publication
(10) Pub. No.: US 2010/0200516 A1
(43) Pub. Date: Aug. 12, 2010

(54) CONCURRENT DISPOSAL AND CONSOLIDATION OF DREDGED SEDIMENT USING HORIZONTAL DRAINS AND VACUUM LOADING

(76) Inventor: Daekyoo Hwang, (US)

Correspondence Address: Daekyoo Hwang, 1671 Bow Tree Drive, West Chester, PA, 19380, US

(21) Appl. No.: 12/368,054

(22) Filed: Feb. 9, 2009

(51) Int. Cl. C02F 7/00

(52) U.S. Cl. 210/747

(57) ABSTRACT

For secure disposal of contaminated sediment, dredged sediment can be consolidated, concurrently as it is discharged to a disposal pond, using horizontal drains installed in the settled sediment and vacuum loading. Horizontal drains are connected to a vacuum pump via collector pipes and a header pipe. Vacuum pump operation consolidates the settled sediment and reduces the volume, enabling continued discharge of dredged sediment. Successive installation of horizontal drains within accumulating sediment and consolidation by vacuum pumping may continue until the disposal pond is filled with consolidated sediment. Vacuum pumping is continued for some period after final cover installation to enhance containment performance by overconsolidation. Also, the horizontal drain system may be used to deliver liquid reagents for sediment treatment or to circulate water for flushing.

### BACKGROUND OF THE INVENTION

1. Field of Invention

This invention relates to remediation of contaminated sediment by secure containment in a disposal facility and more specifically, a method of consolidating dredged sediment or fluid earthen medium in a disposal facility to reduce its volume and to stabilize its physical properties.

2. Description of the Prior Art

Past industrial activities have contaminated sediments in many streams, rivers, lakes, and harbors. The contaminated sediment requires remediation to mitigate its potential impact on ecological receptors, human health, or environmental media. An overview of sediment remediation options is provided below.
In-situ Capping—In-situ capping isolates contaminated sediment from the surrounding surface water body or ecological receptors by placing a protective cover over the contaminated sediment area.
In-Situ Treatment—In-situ treatment refers to treatment of the contaminated sediment at its current location without removal. The treatment methods include biological, chemical, and physical processes.
Removal—Removal is a necessary step for other remediation methods such as ex-situ treatment, off-site disposal or on-site disposal. The most common removal method is dredging. Excavation is also used if the sediment is under a shallow water body that may be drained temporarily using a simple and economical surface water barrier.
Ex-situ Treatment—In this approach, contaminated sediment is removed from its current location and treated. Ex-situ treatment methods include bioremediation, chemical treatment, soil washing, solidification/stabilization and others.
Off-site Disposal—Even after ex-situ treatment, the quality of treated sediment may not fully meet all regulatory requirements. In this case, the treated sediment is taken to an off-site disposal facility (sanitary, industrial or hazardous waste landfill) for safe disposal.
On-site Disposal—Contaminated sediment may be removed and contained, with or without treatment, in an engineered disposal facility built at the project site solely for disposal of the target sediment. The disposal facility filled with sediment is closed as a landfill. Therefore, sediment dewatering is essential. Two common dewatering methods are mechanical dewatering and geotube dewatering.

In mechanical dewatering, dredged sediment is pumped to a mechanical dewatering unit (e.g., a centrifuge, a belt press, or a filter press), dewatered, and cake is placed in the disposal facility. Often, the cake requires solidification/stabilization as cake from mechanical dewatering cannot support earthwork equipment used for disposal work.

Geotube dewatering uses geotubes for dewatering. Geotubes are large filter bags made of geotextile. Dredged sediment is pumped into a geotube and water is allowed to drain, leaving solids in the geotube. After the geotube is filled with pumped-in dredged sediment, the sediment is allowed to drain for some time. When the geotube collapses as water is drained, more dredged sediment is pumped into the geotube. After cycles of filling and draining, the geotube is filled with “drained” sediment. The drained sediment may be dewatered further, if desired, by evaporative drying for several weeks. The dewatered sediment may be taken off site for disposal. For on-site disposal, geotubes may be deployed within the disposal pond before they are filled.

Consolidation Dewatering and Need for Improvements

The present invention relates to consolidation dewatering of dredged sediment for on-site disposal. Consolidation refers to a process of soft clayey soils subject to a load undergoing volume reduction and strength gain as a result of water being squeezed out of the loaded soil volume. As clayey soils do not allow water to flow out easily due to its very low hydraulic conductivity, drainage pathways are provided in the soil volume to accelerate consolidation. The most common way of providing drainage pathways is to insert wick drains vertically into the clay layer with a typical spacing of about 1.5 m. A wick drain is a long strip about 0.5 cm thick and 10 cm wide and consists of a plastic core wrapped with geotextile filter. Wick drains facilitate flow of water from soft clayey soils to the ground surface.

Accelerated consolidation with wick drains has been used for numerous construction projects on soft clayey soils. However, it has not been used for dewatering of dredged sediment in environmental remediation due to one critical limitation. As consolidation is a method of stabilizing a full layer of soft soil, it is applicable to dredged sediment after the disposal operation is completed. However, consolidation dewatering after filling a disposal pond with dredged sediment is not practical for the reasons described below.

To illustrate the point, suppose that consolidation dewatering is attempted for disposal of dredged sediment. Dredged sediment typically contains less than 10% solids by weight as it is pumped as a slurry. After settling in the disposal pond, its typical solids content is around 35% by weight, equivalent to 17% solids and 83% water by volume. As this is too soft to place a final cover for closure, the dredged sediment requires dewatering, in this case by consolidation. The pond surface has to be stabilized first by draining and natural drying to allow equipment access. This step takes very long. The subsequent steps of consolidation work include covering the surface with a geotextile, spreading 0.5 to 1.0 m of sand (top blanket drain) over the geotextile, installing vertical wick drains into the soft sediment with an installation rig working on the top blanket drain, and loading with thick earth fill. As this fill cannot be placed in one step on the very soft sediment, it has to be placed in small lifts, allowing time for consolidation and strength gain before applying the next lift. Thus, this loading step also takes a long time. A large settlement, typically about 50% to 70% of the initial thickness, occurs as a result of consolidation. The final step of pond closure would be surface grading and final cover installation. Surface grading requires the entire fill, or 50% to 70% of the thickness of the material in the disposal pond, to remain in the pond.

The steps described above signify three major problems in consolidation dewatering for on-site disposal of dredged sediment. First, these steps take too long, particularly in stabilizing the surface for equipment access and in applying the load in several lifts. Second, the capacity of the disposal pond is wasted by fill equivalent to 50 to 70% of the pond capacity. Third, the above two reasons make consolidation dewatering costly and impractical. For these reasons, consolidation dewatering is not viable for disposal of dredged sediment in environmental remediation, unless technical improvements are made. The above problems can be overcome if the sediment in the disposal pond is consolidated while dredged sediment is being discharged into the pond. Thus, it is the goal of the present invention to devise a method of consolidation dewatering concurrent with discharge of the dredged sediment into the disposal pond.

In achieving the goal stated above, vacuum loading will play a key role. Vacuum has been often utilized as a means of loading for consolidation projects. In this method, the ground surface is covered with an impermeable membrane and vacuum is applied to the underside of the membrane. This creates an effect of atmospheric pressure working as a load. Although vacuum consolidation offers some advantages, it is often troublesome due to incomplete seals along the edge of the membrane and its cost is significant. A Dutch firm COFRA (see COFRA webpage) practices a vacuum loading method that does not require membrane sealing by connecting the top of vertical wick drains with sealed vacuum lines within the soft clay layer, which is almost impermeable. The present invention intends to extend vacuum consolidation application to horizontal drains using self-sealing properties of fluid earthen medium which is the target for consolidation.

The Corps of Engineers performed a research project evaluating ways of stabilizing dredge spoils from navigation dredging and demonstrated that vacuum underdrainage is an effective way of stabilizing dredge spoil (Hammer, 1981). In this method, a layer of bottom blanket drain is installed in the disposal facility, dredge spoil is discharged, and a vacuum is applied to the bottom blanket drain.

### SUMMARY OF THE INVENTION

The present invention discloses a method of dewatering contaminated sediment by consolidation while it is dredged and discharged to a disposal facility.

As sediment is dredged and pumped to a disposal pond as a slurry, sediment settles at the bottom. As settled sediment accumulates, a plurality of flexible drains are placed horizontally into settled sediment and parallel to each other using a drain installation craft floating on the water surface. These drains are installed 1.2 to 1.8 m apart at the same depth, preferably 1.0 to 1.5 m above the bottom. Horizontal drains preferable for this application are wick drains used for accelerated consolidation of clayey soils or perforated, flexible tube drains wrapped with geotextile filter. Using T-connectors, these drains are connected to a collector pipe which in turn is connected to a header pipe leading to a vacuum pump. Operation of the vacuum pump extracts water from the settled sediment layer surrounding the horizontal drains and consolidates the settled sediment layer. Volume reduction resulting from this consolidation creates more disposal capacity in the disposal pond otherwise unavailable and allows continued discharge of dredged sediment into the disposal pond.

As the settled sediment builds up further above the consolidating layer in the disposal pond, another plurality of horizontal drains are installed at a new depth, preferably 1.8 to 3.0 m higher than the first depth in the sediment layer. Repeating this process of discharging dredged sediment and installing horizontal drains along with vacuum pumping operation allows continued dredging and discharge of sediment to fill the disposal pond with consolidated sediment. This method offers three advantages over the conventional method of complete disposal followed by consolidation using vertical wick drains (with or without vacuum): no waste of pond capacity for a large volume of fill, faster completion of the project, and project completion for a lower cost.

Upon completion of dredging and disposal operation, the surface of the disposal pond is graded with fill to achieve positive drainage and a final cover is installed to close the disposal pond as a landfill. After installing the final cover, vacuum pumping continues for some time to overconsolidate the consolidated sediment. Overconsolidation is an effective means of minimizing post-closure leachate generation and settlement of the final cover. The present invention may be used to treat contaminated sediment in the disposal pond by injecting liquid reagents via the horizontal drains for bioremediation, chemical oxidation, or stabilization. Contaminants in the sediment may be flushed out by injecting clean water or a cleaning solution through a set of horizontal drains and extracting the same through another set of horizontal drains. This treatment step may be implemented either before or after final cover installation.

The present invention can be used for dewatering, stabilization and volume reduction of any fluid earthen medium stored in a pond, such as coal ash ponds, gypsum ponds, mine tailings ponds, and sludge ponds. In addition, this invention can be used to improve the stability of large dams containing a fluid earthen medium by lowering the water level in the dam and by increasing the strength of the unstable medium behind the dam.

### BRIEF DESCRIPTION OF THE DRAWINGS

FIG. 1A through FIG. 1F disclose typical steps of implementing the present invention from start to finish.

FIG. 1A is a profile of a typical disposal pond built for disposal and containment of dredged sediment.

FIG. 1B is a profile of a disposal pond with dredged sediment being discharged.

FIG. 1C is a profile of a disposal pond as horizontal drains are placed in the settled sediment and connected to a vacuum pump.

FIG. 1D is a profile of a disposal pond with a plurality of horizontal drains placed at different depths and connected to a vacuum pump.

FIG. 1E is a cross-section of a preferred arrangement of multi-level horizontal drains as an equilateral triangle in a disposal pond.

FIG. 1F is a profile of a disposal pond when sediment disposal is completed and a final cover is installed.

FIG. 2 is a schematic showing essential components of a floating craft used to install horizontal drains.

FIG. 3 is a plan view of a set of horizontal drains placed at a same depth and connected to a vacuum pump via T connectors, collector pipes and a header pipe.

FIG. 4 is a profile of a disposal pond wherein alternating sets of horizontal drains are used for injection and extraction of treatment reagent.

FIG. 5 is a profile of a dam and disposal pond system wherein horizontal drains and vacuum consolidation are used to enhance the stability of the dam.

### DETAILED DESCRIPTION OF PREFERRED EMBODIMENTS

The present invention discloses a method of consolidation dewatering for pond disposal of dredged sediment, concurrently as dredged sediment is discharged into the disposal pond, by horizontally installed drains and vacuum loading. The steps of implementing the present invention is described herein.

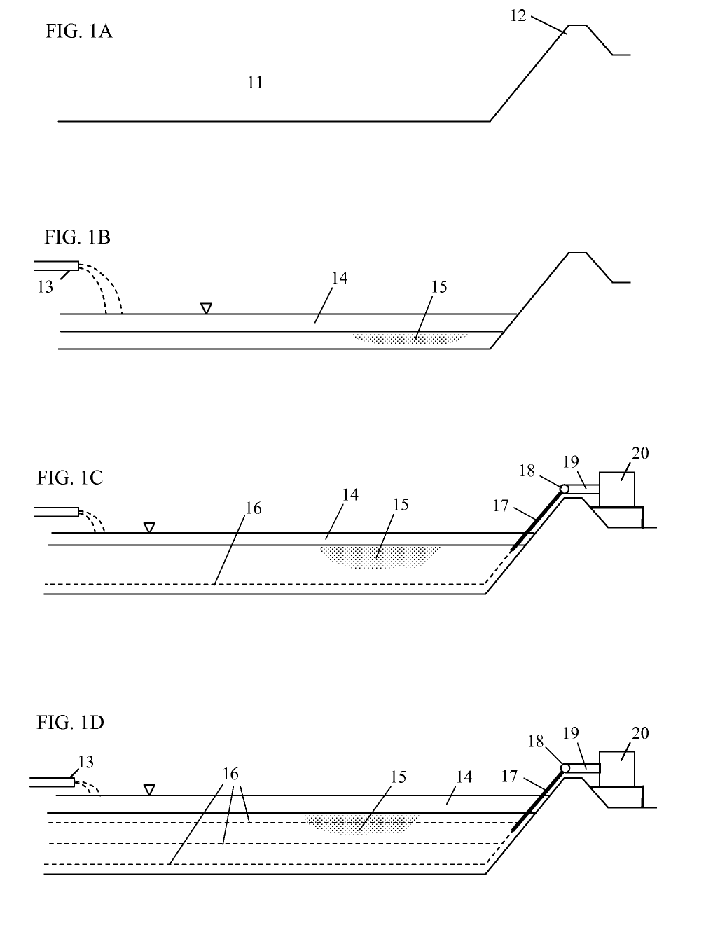

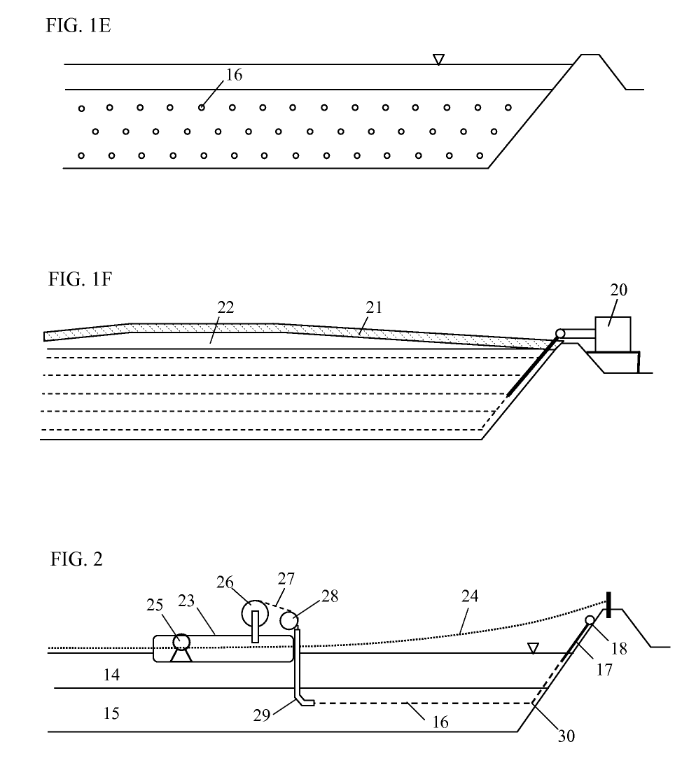

FIG. 1A through FIG. 1F disclose a preferred embodiment of the present invention from start to finish.

Referring to FIG. 1A, a disposal pond 11 is built to receive dredged sediment, often with a perimeter dike 12 and some excavation of the ground.

In FIG. 1B, dredged sediment 14 is discharged to disposal pond 11 via a discharge pipe 13. At this stage, dredged sediment 14 is a slurry. As discharge of dredged sediment 14 continues, solids in dredged sediment 14 settle out at the bottom and the thickness of settled sediment 15 gradually increases.

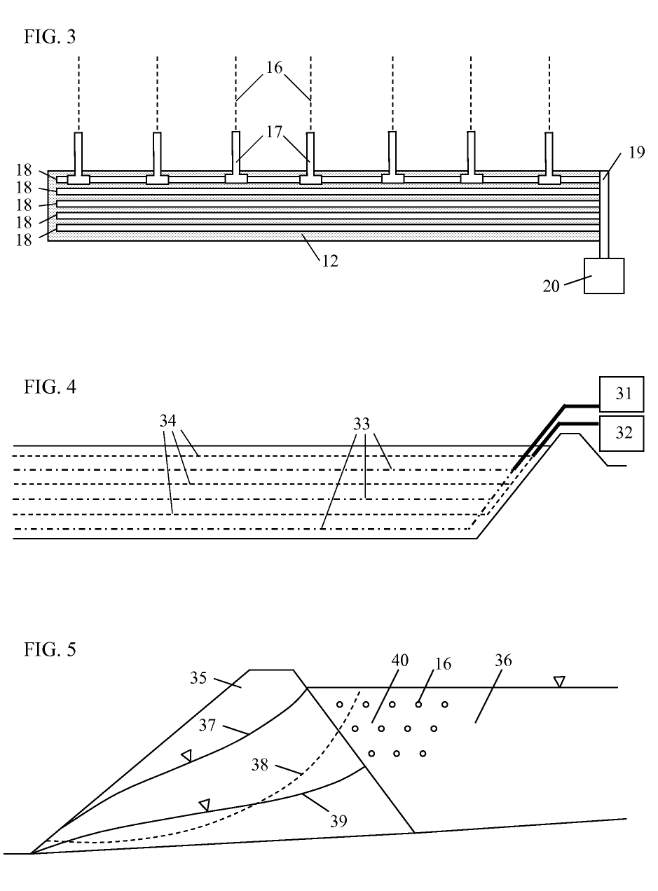

FIG. 1C shows the profile of disposal pond 11 when the first set of horizontal drains 16 is installed. When the thickness of settled sediment 15 is sufficient, i.e., at least 1.5 m, a plurality of horizontal drains 16 are installed at about 1.0 to 1.5 m above the bottom of disposal pond 11. Horizontal drains 16 are installed from a floating craft as depicted in FIG. 2. Preferably, horizontal drains 16 must be at least 0.5 m below the surface of settled sediment 15 to keep horizontal drains 16 from floating. Preferable horizontal drains are wick drains used for consolidation of soft clay soils or perforated, flexible tube drains wrapped with geotextile. Horizontal drains 16 are installed parallel to each other, at a distance of 1.2 to 1.8 m, depending on the hydraulic conductivity of settled sediment 15. Horizontal drains 16 are connected to a vacuum pump 20 via a T-connector 17, a collector pipe 18, and a header pipe 19. Details of this embodiment are further depicted in FIG. 3.

The operation of vacuum pump 20 exerts suction along header pipe 19, collector pipes 18, and horizontal drains 16. This suction extracts water from the settled sediment 15 surrounding horizontal drains 16, leading to consolidation of settled sediment 15. As a result, the thickness of settled sediment 15 decreases and more capacity is created in disposal pond 11, allowing continued discharge of dredged sediment 14 into disposal pond 11.

As continued discharge of dredged sediment 14 further increases the thickness of settled sediment 15, another set of horizontal drains 16 is installed, preferably about 1.8 to 3.0 m above the first set of horizontal drains, depending on the density of settled sediment 15 and expected final density after consolidation, as shown in FIG. 1D. FIG. 1E is a cross-section view of FIG. 1d, showing a preferred embodiment of horizontal drains 16 as an equilateral triangle. Because the vertical separation distance of horizontal drains 16 in FIG. 1E decreases over time due to on-going consolidation, the equilateral triangle can be formed only during a limited period of time. The preferred timing of forming the equilateral triangle is toward the final stage of consolidation wherein the rates of consolidation slow down.

Continuing discharge of dredged sediment 14 and concurrent consolidation as described above will eventually fill disposal pond 11 with “consolidated sediment.” Then, disposal pond 11 is closed as a landfill by installing a final cover 21 over the entire area as depicted in FIG. 1F. Prior to cover installation, the central area of disposal pond 11 may be raised with fill 22 to promote surface drainage.

FIG. 2 discloses a drain installation craft. The installation craft consists of a barge 23, a control cable 24, a capstan winch 25, a drain roll 26, a feed roller 28, and a drain guide 29. Drain 27 is unreeled from drain roll 26 and fed into drain guide 29 via feed roller 28. The installation craft moves typically straight backward using control cable 24 and capstan winch 25. First, drain 27 is inserted to the top of drain guide 29 and pulled out of the bottom end of drain guide 29. The guide and feed roller assembly is made to move vertically up and down to enable pulling of drain 27 from the bottom end of drain guide 29. Next, the end of drain 27 is joined to collector pipe 18 using T-connector 17, as will be further described with FIG. 3. After connecting drain 27 with collector pipe 18, drain 27 is anchored temporarily at a temporary anchoring point 30 using an anchoring device, preferably a trough-shaped weight, to keep drain 27 in place, and the installation craft moves backward using control cable 24 and capstan winch 25. As the craft moves, drain 27 is unreeled from the drain roll 26 and released from the bottom end of drain guide 29 into settled sediment 15. Settled sediment 15 is very soft at this stage and the depth of installation is only about 0.5m from the surface of settled sediment 15. Therefore, the power requirement for the installation craft is not high. The installation craft may be equipped with multiple drain roller-feed roller-drain guide sets to install multiple horizontal drains in one pass.

Referring to FIG. 3, T-connector 17 connects horizontal drain 16 and collector pipe 18. The two joints with collector pipe 18 are above dredged sediment 14 as shown in FIG. 2 and therefore, must be connected air tight to maintain vacuum in collector pipe 18. However, the joint with horizontal drain 16 does not require air-tight connection as this joint is embedded in settled sediment 15 that provides sealing against leakage of air at this joint. As a result, the present invention essentially uses the self-sealing property of dredged sediment 14 and settled sediment 15 to maintain vacuum pressure in horizontal drains 16. The use of this self-sealing property offers an economical and simple way of vacuum consolidation without sealing the entire surface area with a cumbersome and expensive liner. FIG. 3 shows multiple collector pipes 18, each to be connected to a plurality of horizontal drains 16, preferably from a particular depth. These collector pipes 18 need to be deployed neatly along perimeter dike 12.

A second embodiment of the present invention is to enhance containment performance by overconsolidation. Overconsolidation is a term referring to consolidation of soft clays under a load substantially exceeding the long-term, normal load expected at the site. In this embodiment, vacuum pump 20 is operated for several weeks to a few months after final cover installation. Then, the entire sediment in disposal pond 11 is consolidated under the combined load of final cover 21, fill 22, and vacuum pressure. As this combined load forces the entire sediment to consolidate under a more than normal load of final cover 21 and fill 22, the sediment is “overconsolidated.” The advantage of overconsolidation is obvious; the overconsolidated sediment in disposal pond 11 will no longer release water (in this case, leachate) or settle further, after vacuum loading is removed.

A third embodiment of the present invention is in-situ treatment of sediment using the horizontal drains already in the sediment as a pathway to deliver liquid reagents. In general, the hardest problem with in-situ treatment of sediment is delivery of reagents uniformly into the target sediment volume. With horizontal drains embedded in the sediment volume at close, regular intervals, it is now very simple to deliver treatment reagents in a liquid form using an injection pump. Various biological, chemical or physical reagents may be used for this purpose. FIG. 4 discloses this embodiment wherein an injection pump 31 injects reagents through a set of horizontal drains 33 and an extraction pump 32 extracts reagents through another set of horizontal drains 34. Injecting clean water or a cleaning solution and extracting the same in this embodiment can flush the contaminants from the sediment for subsequent ex-situ treatment of liquid.

A fourth embodiment of the present invention is disclosed in FIG. 5, wherein a dam 35 containing fluid earthen medium 36 is stabilized by installing horizontal drains 16 and applying vacuum consolidation using the self-sealing properties of earthen fluid medium 36. Initially, dam 35 may be unstable as a high water table 37 reduces shear resistance of soil along potential failure circle 38 and fluid earthen medium 36 in the pond exerts a high pressure on the sliding block above potential failure circle 38. Using the present invention, water level 37 in dam 35 is lowered to a lowered water table 39 and the fluid earthen medium behind dam 35 is consolidated to a stabilized earthen medium 40 having a higher shear strength. As a result, the shear resistance along potential failure circle 38 increases significantly and the dam and pond system becomes stable.

A fifth embodiment of the present invention is consolidation of fluid earthen medium in a disposal pond for the purpose of volume reduction and stabilization using horizontal drains installed from a floating craft and vacuum consolidation assisted by the self-sealing property of the fluid earth medium.

I claim:

1. A method of consolidating dredged sediment, or more generally any fluid earthen medium that contains more than 60% by volume of water and less than 40% by volume of fine-grained solids, in a disposal pond concurrently while discharging said dredged sediment or fluid earthen medium to the disposal pond, by installing a plurality of horizontal drains into the settled sediment from a floating craft and by applying vacuum to said horizontal drains, using the self-sealing property of said dredged sediment or fluid earthen medium to maintain vacuum in said horizontal drains.

2. A method in accordance with claim 1, further comprising the step of applying vacuum loading for some period after installation of a final cover to overconsolidate the consolidated sediment or earthen medium within the disposal facility.

3. A method in accordance with claim 1, wherein a liquid reagent, clean water, or a cleaning solution is injected and extracted via horizontal drains to degrade, destroy, flush, or immobilize contaminants in the sediment or earthen medium after disposal in the disposal facility.

4. A method of improving the stability of a dam storing any fluid earthen medium by lowering the water level in the dam and by increasing the strength of said medium, using the steps of installing a plurality of horizontal drains into said medium from a floating craft and applying vacuum to said horizontal drains using the self-sealing property of said fluid earthen medium to maintain vacuum in said horizontal drains.

5. A method of consolidating any fluid earthen medium in a disposal pond by the steps of installing a plurality of horizontal drains into said medium from a floating craft and by applying vacuum to said horizontal drains connected to a vacuum pump, using the self-sealing property of said fluid earthen medium to maintain vacuum in said horizontal drains.
